(19) United States
(12) Patent Application Publication
(10) Pub. No.: US 2008/0083781 A1
(43) Pub. Date: Apr. 10, 2008

(54) Cleaning solution dispenser

(76) Inventor: Kevin Saxman, St. Petersburg, FL (US)

Correspondence Address: Kevin Saxman, 1977 Illinois Ave NE, St. Petersburg, FL, 33703, US

(21) Appl. No.: 11/998,770

(22) Filed: Dec. 3, 2007

Related U.S. Application Data
(63) Continuation-in-part of application No. 11/167,467, filed on Jun. 27, 2005.

(51) Int. Cl. B67D 5/64

(52) U.S. Cl. 222/133; 222/630

(57) ABSTRACT

A cleaning dispensing system including a chamber containing a cleaning fluid therein. The chamber has an inlet and an outlet. An elongated venturi tube is screwed into the inlet of the chamber and extends through the contained to centrally located therein. The venturi tube extends into the outlet of the chamber and creates a gap at this location and creates a venturi effect at this location which gap can be adjusted as to its strength and velocity. An additional cleaning fluid container can be added to the chamber to extend the duration of any dispensing process. The dispensing system can be attached to a cooling system of an interior combustion engine of a car or a boat. It is preferred that the boat motor is operating to take advantage of the internal fluid pump including its impeller which will also be cleaned at the same time.

This application is a Continuation-In-Part of application Ser. No. 11/167,467 having a filing date of Jun. 27, 2005

### FIELD OF THE INVENTION

Internal combustion engines have a cooling fluid flowing there through which, in most instances, is circulated or accelerated by way of a pump driven by the engine. The cooling fluid in most instances flows through a radiator to aid in the cooling process. Such cooling systems are used in gasoline or diesel engines or in outboard or inboard motors.

### BACKGROUND OF THE INVENTION

In outboard or inboard motors, the engines are mostly cooled by pumping normal river, lake or sea water through the engine and its associated power drive train. This type of cooling system is known to develop sludge and salt deposits within the cooling circulation system. In order to maintain a proper functioning of these engines, they need to be cleaned or cleansed at regular intervals. This is mostly done by attaching a hose to the engine and by passing clean water through the cooling system. This can be done with or without the engine operating. Solution dispensers are well known that dispense a fluid for cleaning and for dispensing fertilizers in a landscaping setting, for example.

### BACKGROUND OF THE INVENTION

U.S. Pat. No. 1,611,400 shows an apparatus for applying fertilizer wherein the fertilizer is contained in a chamber and wherein a first inlet controls the amount of water to be admitted into the chamber and a second tube exits from the chamber to allow the fertilizer material to exit into a hose.

U.S. Pat. No. 2,235,278 shows a fertilizing dispenser system of the above noted patent. However, this dispenser includes a venturi system to accelerate the dispensing of the material while mixing with the material contained in the chamber.

U.S. Pat. No. 3,166,114 illustrates a dispensing system for fluid soluble materials. The materials are contained in a flexible bag that has an inlet stem reaching into the bottom of the bag and an outlet stem arranged at an upper area of the bag. The upper outlet stem creates a suction because it is located at a restricted venturi tube.

U.S. Pat. No. 3,194,444 discloses a dispenser for entraining an additive into a stream of water. The disclosure is similar to the immediately cited patent above except of using a flexible bag a rigid container is attached to the dispensing tube.

U.S. Pat. No. 3,357,598 illustrates an adjustable liquid dispenser. Contrary to the inventive concept, the venturi tube is placed above the container rather than extending through the container as is disclosed in this application.

U.S. Pat. No. 3,643,688 shows a device for the continuous mixing of beverage components in a predetermined quantity ratio. The venturi tube is fed from the outside of the container and not from within.

U.S. Pat. No. 4,121,773 discloses a shower head dispenser for bath oil or the like. The dispenser has an axial venturi bore there through and a pair of transverse bores intercepting the axial bore, one of which intercepts the axial bore at a venturi throat and the other of which intercepts the axial bore upstream of the throat.

U.S. Pat. No. 5,626,291 illustrates a cleaning solution spraying system for cleaning roofs and other outside areas. The cleaning unit consists of a venturi device which will accelerate the flow of the fluid and an intake at the point of the venturi through which the cleaning material is sucked into the unit and is expelled at the nozzle.

U.S. Pat. No. 6,872,292 discloses a fertilizer dispenser with an inlet compartment and an outlet compartment. An outlet is located in the bottom of the outlet compartment. No venturi effect can be gleaned from the description.

### BRIEF DESCRIPTION OF THE INVENTION

The inventive concept is mainly directed to cleaning the interior cooling system of boat motors that, when in operation, uses the water on which the boat rides as a cooling medium. The cooling systems of these boats have to be cleaned frequently. This is accomplished by providing a chamber having a fluid inlet and a fluid outlet. The fluid inlet has a larger inside diameter when compared to the diameter of the outlet. The inlet additionally has a relatively long venturi tube attached to the entrance of the chamber and across and through the chamber into the fluid outlet of the chamber including through the fluid cleaning medium that is contained in the chamber and dispenses the same into the outlet and further transports the thus obtained mixture into the engine of the boat cooling system.

### BRIEF DESCRIPTION OF THE DRAWINGS

FIG. 1 is a side view of the dispenser having an additional container attached thereto;

FIG. 2 is a schematic representation of the inventive dispenser being attached to the cooling system of an outboard motor;

FIG. 3 is a more detailed illustration of FIG. 1;

FIG. 4 is a cross-section through the dispenser;

FIG. 5 is an exploded view of the interior parts of the dispenser.

### DETAILED DESCRIPTION OF THE INVENTION

FIG. 1 shows the dispenser from a side view. It can be seen that the chamber 10 is much larger than the incoming fluid hose in hose 11 and the outgoing fluid in hose 12. This size difference has a purpose in that the cleaning media will be added or placed into chamber 10 by way of a cap 16. In this particular view of FIG. 1, there is even an additional container 15 added to the dispenser chamber 10 to increase the amount of the cleaning media that can be used for a cleaning job and to increase the duration of the same. The fluid incoming hose 11 is connected to the chamber 10 by way of a compression fitting 13 and the outlet hose is connected to the chamber 10 by way of a compression fitting 14. The arrow A indicates the fluid flow direction through the chamber 10.

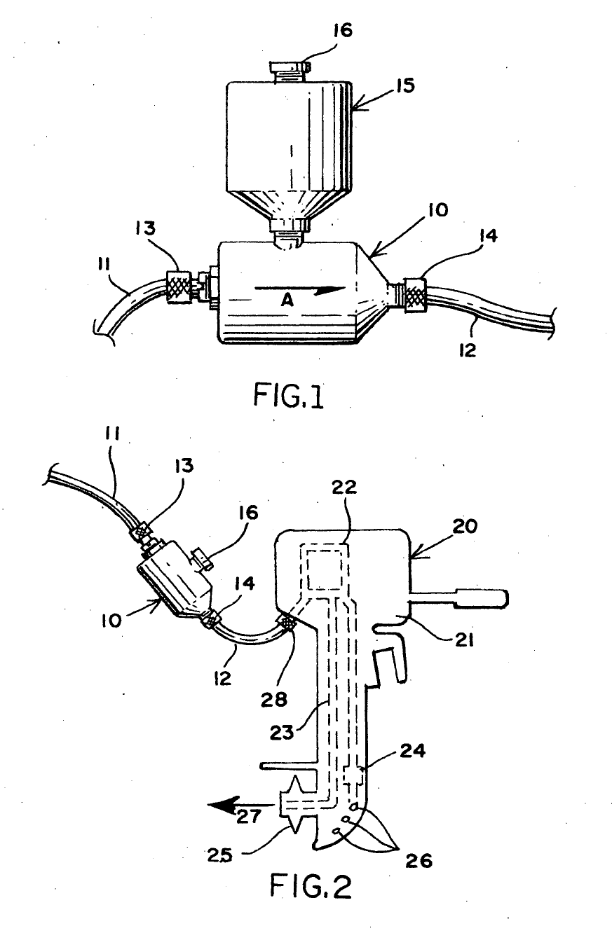

FIG. 2 shows the cleaning dispenser system as it is attached to an outboard motor 20. The chamber is again shown at 10 including the connector hose 12 attached to the outboard motor 20 by way of a compression fitting or connection 18. The outboard motor 20 shows the cooling circuit schematically as it continues downwardly at 23 into the drive train of the outboard motor 20. The cooling fluid is expelled at 27 through the hollow axle shaft of the propeller 25. The intake of the cooling fluid is shown at 26 and the water is propelled throughout the cooling system by the pump 24. It can now be seen that when the cleaning chamber 10 is connected to the cooling circuit of the outboard motor 20 by way of the coupling 28, the cleaning fluid emanating from the chamber 10 is circulated throughout the cooling circuit system of the outboard motor by way of the pressure of the incoming hose 11 and is assisted by the water pump 24 when the motor is running. The latter is preferred because it would also clean the impeller (not shown) in the water pump.

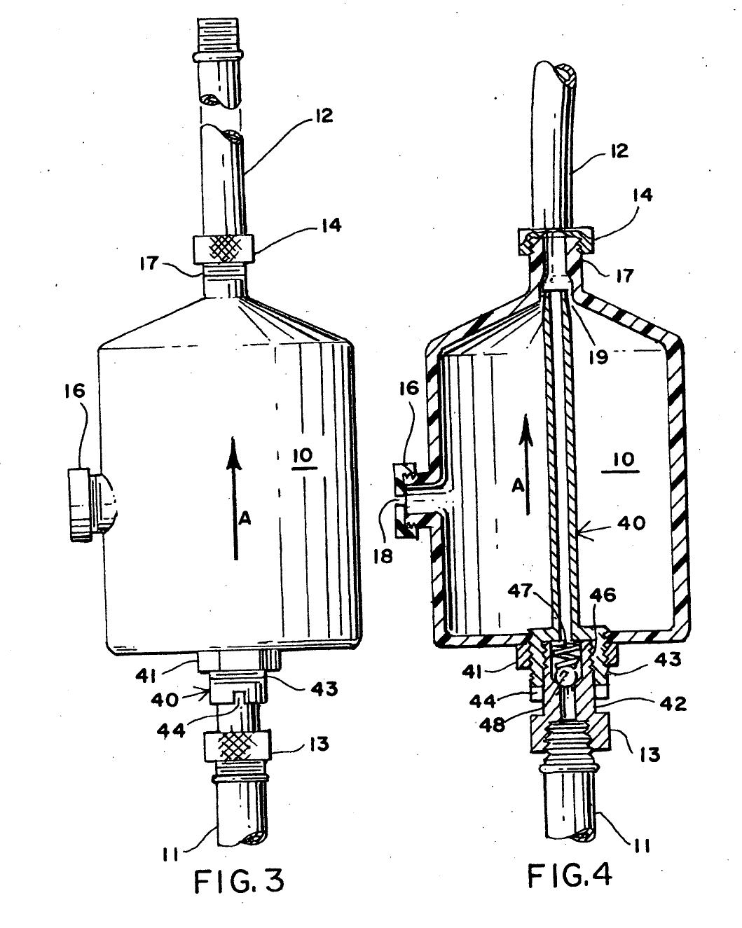

FIG. 3 is a side view of chamber 10 showing the direction of the water pressure flow there through by the arrow A. The incoming water pressure, by way of the hose 11 which is coupled to the chamber 10 at 13, enters the chamber 10 at the coupling 41.

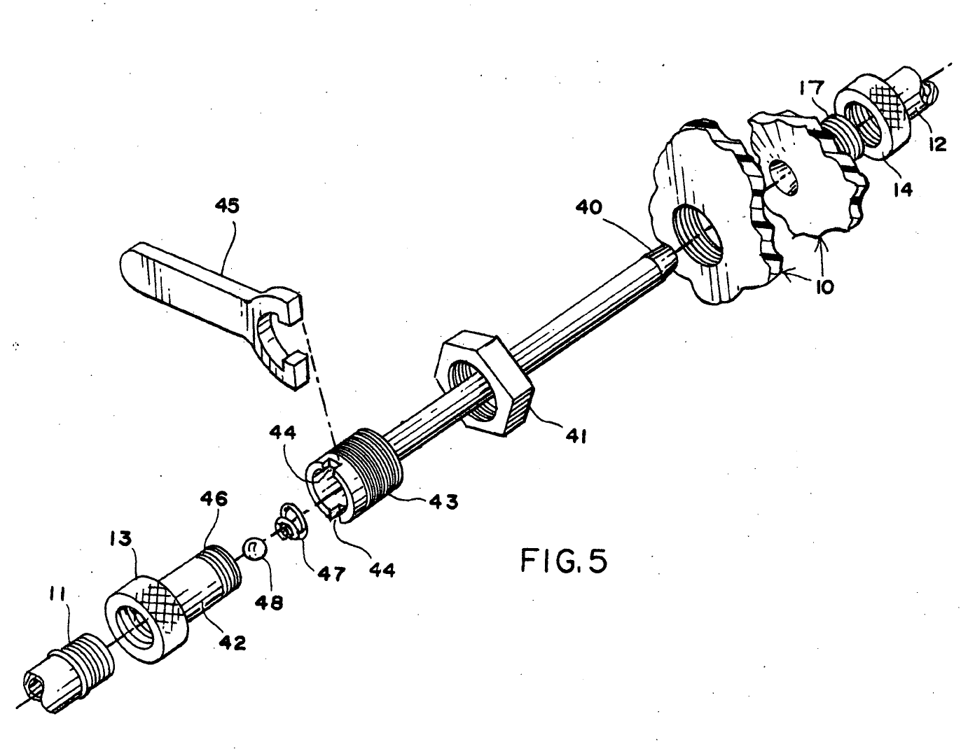

FIG. 4 is a cross-section through the chamber 10. Again, the direction of the water flow is indicated by the arrow A. The incoming water end of the chamber 10 has a coupling 43 threaded therein which continues into the chamber 10 as an elongated venturi tube 40. The elongated venturi tube 40 is located centrally within the chamber 10 and ends within the exit end of the chamber 10 at 19 to establish a venturi effect at that location. The venturi effect can be influenced as to its strength or velocity by threading the coupling 43 of the venturi tube more or less into the chamber 10 which will then more or less extend into the exit 19 of the chamber 10 where this venturi effect will pick up and mix with the cleaning fluid located in the chamber 10. The coupling 43, once adjusted in a desired position, is locked into place by the lock nut 41. Contained within the coupling 43 entrance is a check valve consisting of a spring 47 and a ball 48. The spring 47 will bias the ball 48 into a closed position when no water pressure is emanating from the hose 11. This will prevent any fluid pressure prevailing within the chamber 10 from leaking back into the hose 11. The cap 16 has a vent hole therein, the operation of which will be explained below.

FIG. 5 is an exploded view of the chamber showing the elements contained therein. The same reference characters are shown in this Fig. as were shown in previous Figs. The ends of the chamber 10 are shown at the right side of FIG. 5 in broken lines. The threaded end 43 of the elongated venturi tube 40 is shown as containing notches 44 therein. As mentioned with regard to FIG. 4, the venturi effect can be adjusted by screwing the coupling more or less into the chamber 10. This may be accomplished by using the tool 45 which will engage the notches 44 and to thereby turn the venturi tube more or less into the chamber to thereby obtain the desired results.

### Operation

When a boat motor, inboard or outboard, has to be cleaned, the chamber 10 is filled with the appropriate cleaning fluid and the motor is turned on, preferably. Also the outside water is turned on under pressure. This will open the check valve 47/48 and water under pressure enters the elongated venturi tube 40. Because of the presence of gap 19, the thus established venturi effect will suction the cleaning fluid contained in the chamber 10 out of the chamber 10 and propel the same into the exit hose 12 and from there into the cooling circuit of the motor. At this point it is imperative that a venting hole 18 be present in the cap 16 so that air can rush into the chamber as the cleaning fluid leaves the same. If it was not for the presence of the venting hole 18, the cleaning fluid in the chamber 10 would represent a static body that could not be evacuated by the venturi tube 40. In order to prolong the cleaning action of the system, an additional tank or container 15 could be added by screwing the same on to the chamber 10 when the cap 16 is removed there from. The cap 16 with its venting hole 18 would then be screwed onto the additional container or tank 15.

At this point it should be noted that this dispenser cleaning system could also be used in cleaning the cooling systems of internal combustion engines. One of the radiator would have to disconnected and the outlet hose 12 of the chamber 10 would have to be connected at this location.

The dispensing system, as disclosed, could still further be used to clean driveways, patios or roofs of a residence. It is merely up to the user to fill the chamber 10 with the appropriate cleaning fluid. No adjustments would have to be made to the system itself. It may be advisable to increase the water pressure of the incoming fluid or to adjust the velocity or strength of the venturi effect by turning the coupling 43 in or out of the chamber 10 with the aid of the tool 45 shown in FIG. 5.

What is claimed is:

1. A cleaning fluid dispensing system including an enlarged: chamber containing a cleaning fluid therein, said chamber having an inlet and an outlet, an elongated venturi tube is screwed into said inlet of said chamber and extends through the interior of said chamber to be located centrally therein, said venturi tube extends into said outlet of said chamber and leaves a gap at this location to establish a venturi effect at this location, a cap is located on said chamber and having a vent hole therein.

2. The fluid dispensing system of claim 1 including means for adjusting said gap between said elongated venturi tube and said outlet of said chamber.

3. The fluid dispensing system of claim 2, wherein said means for adjusting is a tool engaging notches located at an exterior of said venturi tube which is screwed into said inlet of said chamber.

4. The fluid dispensing system of claim 1 including an additional cleaning fluid container attached to said chamber to extend the duration of a cleaning process.

5. The fluid dispensing system of claim 1 including means for attaching said system to a cooling circuit of an internal combustion engine.

6. The fluid dispensing system of claim 5, wherein said internal combustion is a boat motor.
